(19) United States
(12) Patent Application Publication
(10) Pub. No.: US 2026/0270304 A1
(43) Pub. Date: Sep. 10, 2026

(54) Automated Device Reconfiguration to Facilitate Voice Communication Service

(71) Applicant: Google LLC, Mountain View, CA (US)

(72) Inventors: Po-Ying Chuang, Taipei (TW); Kuan-Wei Chen, New-Taipei City (TW); Chien-Chun Huang Fu, Taipei (TW)

(21) Appl. No.: 19/167,211

(22) PCT Filed: Mar. 31, 2023
(86) PCT No.: PCT/US2023/065188

§ 371 Date: Sep. 19, 2025

(51) Int. Cl. H04L 65/1096; H04L 65/1016

(52) U.S. Cl. CPC H04L 65/1096; H04L 65/1016

(57) ABSTRACT

A method and system for automatically configuring a device to facilitate voice communication by a device that is equipped to support voice-call service. An example method includes (i) the device detecting that, though it is equipped to support voice-call service, it is not configured to allow the voice-call service and (ii) in response, the device automatically reconfiguring itself to allow the voice-call service. In an example implementation, the voice-call service is Internet Protocol (IP) Multimedia Subsystem (IMS) based voice-call service, the UE stores an Access Point Name (APN) Control List (ACL), the detecting that the UE is not configured to allow the voice-call service involves the UE detecting that the ACL does not list an IMS APN as an allowed APN, and the UE automatically reconfiguring itself to allow the voice-call service involves the UE adding the IMS APN to the ACL as an allowed APN.

### BACKGROUND

A typical wireless communication system includes a number of access nodes configured to provide wireless coverage in which to serve user equipment devices (UEs) such as cell phones, tracking devices, wirelessly equipped personal computers, gaming devices, Internet of Things (IoT) devices, and other wirelessly-equipped devices. In addition, the system may include a core network having a user-plane subsystem that provides connectivity between access nodes and application servers or other entities, and having a control-plane subsystem for managing UE and core-network service. With this arrangement, when a UE is positioned within coverage of an access node, the UE may be able to engage in air-interface communication with the access node and may thereby be able to communicate through the access node and the core network with remote entities.

Such a system could operate in accordance with one or more radio access technologies (RATs), which may define the physical structure of the air interface between access nodes and UEs and may also define associated procedures for handling service of UEs.

The wireless industry has developed various generations of RATs over the years and continues to develop new generations of RATs. Examples of these RATs include, without limitation, (i) “4G” Long Term Evolution (LTE), which facilitates mobile broadband service using technologies such as orthogonal frequency division multiplexing (OFDM) and multiple input multiple output (MIMO), (ii) “5G NR” (5G New Radio), which may use a more scalable OFDM air interface and other advanced features to support higher data rates and advanced applications, and (iii) “6G”, which might support even higher data rates, possibly by making use of millimeter wave and Terahertz spectrum.

When a UE first powers on or otherwise enters into coverage of an access node operating under a given RAT, the UE may engage in signaling with the access node to establish an air-interface connection between the UE and the access node. Further, the UE may engage in signaling through the access node with the control-plane subsystem of the core network, to register for service with the core network and to trigger setup for the UE of one or more user-plane connections that would enable the UE to engage in communication on one or more other computer networks.

In some systems, each of the one or more user-plane connections that gets set up for the UE is referred to as an “Access Point Name” or “APN,” as the connection may extend between the UE and a respective core-network gateway or other entity (virtual or physical) that interfaces with one or more external computer networks, platforms, or the like. In practice, setting up each such APN for the UE may involve assigning to the UE a respective Internet Protocol (IP) address that the UE could use to engage in packet-based communication on an associated computer network through a respective core-network gateway. Further, as to each such APN that gets set up for the UE, the control-plane subsystem may also coordinate setup of one or more bearers or Quality of Service (QoS) flows each effectively defining a virtual packet tunnel extending between the UE and the gateway and having associated QoS parameters for handling respective communications.

APNs may be provided for various purposes, to serve various needs. For instance, an “Internet APN” may be provided to support general internet communications, such as web browsing, email communications, and file transfers. Further, one or more service-specific APNs may be provided to support communications of specific types and/or with specific networks or platforms.

### SUMMARY

One APN that is of particular importance for many UEs is an “IMS” APN, which provides for communications with an Internet Protocol (IP) Multimedia Subsystem (IMS) to facilitate packet-based real-time media service, particularly voice-over-IP (VoIP) call service.

With certain RATs, a UE that is equipped to support voice-communication service may make use of an IMS APN to interact with an IMS in order to be able to place and receive voice calls. A technical problem that may occur in practice, however, is that such a UE may be configured in a manner that prevents the UE from making use of the IMS APN. For instance, the UE may have an APN Control List (ACL) that does not list the IMS APN as an allowed APN. Faced with that configuration, the UE may unfortunately be unable to engage in voice-communication service through a desired wireless communication system if at all.

The present disclosure provides a mechanism that may help to address this technical problem. In accordance with the disclosure, a UE that is equipped to support voice-call communication may detect that the UE is not configured to allow a voice-call service, and the UE may responsively reconfigure itself to allow the voice-call service.

In an example implementation, for instance, the UE may detect that the UE is configured to not allow IMS-based voice-call service. For example, the UE may store an ACL, and the UE may detect that the ACL does not list an IMS APN as an allowed APN. In response, the UE may then automatically reconfigure itself to allow the voice-call service, which may involve the UE adding the IMS APN to the ACL as an allowed APN.

Further, upon detecting that the ACL does not list the IMS APN, the UE may engage in a test process to control whether the ACL should list the IMS APN. For instance, the UE may attempt to have a serving wireless communication system establish an IMS APN connection for the UE, and (i) if that attempt succeeds, then the UE may conclude that the ACL should list the IMS APN or (ii) if the attempt fails, then the UE may conclude that the ACL should not list the IMS APN.

These as well as other aspects, advantages, and alternatives will become apparent to those of ordinary skill in the art by reading the following detailed description, with reference where appropriate to the accompanying drawings. Further, it should be understood that the descriptions provided in this summary and below are intended to illustrate the invention by way of example only and not by way of limitation.

### BRIEF DESCRIPTION OF THE DRAWINGS

FIG. 1 is a simplified block diagram of an example communication system in which various disclosed principles could be applied.

FIG. 2 is a simplified block diagram of an example UE.

FIG. 3 is a flow chart illustrating a method that can be carried out in accordance with the disclosure.

FIG. 4 is another flow chart illustrating a method that can be carried out in accordance with the disclosure.

FIG. 5 is another flow chart illustrating a method that can be carried out in accordance with the disclosure.

### DETAILED DESCRIPTION

An IMS typically includes various proxy servers and media servers configured to provide VoIP-call service for served UEs. When a cell phone or other such voice-capable UE initially connects with an access node and registers with an associated core network, the core network may set up for the UE an IMS APN, so that the UE can then communicate with the IMS in order to place and receive VoIP calls.

In general, the process of setting up this IMS APN may involve the UE sending to the control-plane subsystem a request to set up for the UE of the IMS APN, and the control-plane subsystem responding to that request by engaging in signaling to coordinate setup of the IMS APN. For instance, the control-plane subsystem may respond to the UE's request by assigning to the UE an IP address that the UE can use to communicate with the IMS and by configuring for the UE a default IMS bearer that extends between the UE and an associated core-network gateway. This default IMS bearer may be a best-efforts bearer that has a QoS level appropriate for carrying packet-based control signaling, such as Session Initiation Protocol (SIP) signaling, between the UE and the IMS.

Once this default IMS bearer is in place, the UE may then engage in signaling with the IMS to register for service with the IMS. For instance, the UE may transmit a SIP REGISTER message to the IMS, over the UE's default IMS bearer through the core network, and the IMS may respond to the UE with a SIP 200 OK to confirm successful IMS registration. This IMS registration process may establish that the IMS is an anchor for voice-call service for the UE, enabling the UE to then place and receive voice calls through the IMS.

After the UE has registered with the IMS, when the UE then places a voice call to a remote device or a remote device places a voice call to the UE, the IMS may work to connect the voice call. For instance, the IMS may engage in SIP signaling with the UE to establish one leg of the voice call between the IMS and the UE, the IMS may engage in SIP or other signaling with the remote device or an associated system to establish another leg of the voice call between the IMS and the remote device, and the IMS may bridge those two legs together to enable the UE and the remote device to communicate with each other. Further, to help ensure that this voice communication is given priority treatment by the user-plane subsystem of the core network, the IMS may also engage in signaling with the control-plane subsystem of the core network to cause the core network to add to the UE's IMS APN a dedicated IMS bearer for carrying voice traffic of the call. This dedicated IMS bearer, which may likewise extend between the UE and the associated core-network gateway, may be a guaranteed-bit-rate (GBR) bearer with a QoS level suitable for carrying packetized voice traffic in real-time between the UE and the IMS.

With the call so connected, the UE may then engage in voice communication with the remote device. Namely, packetized voice traffic could flow (i) between the UE and the IMS through the UE's dedicated IMS bearer between the UE and the core-network gateway and (ii) between the IMS and the remote device, thereby enabling a user of the UE to talk with a user of the remote device. Further, once this call ends, additional signaling may then ensue to tear down the call legs and to release the UE's dedicated IMS bearer, in order to conserve resources until a next voice call is initiated to or from the UE.

The above process, or variations of the above process, may assume as a basic matter that the UE at issue is a voice-capable device, i.e., a device that is suitably equipped to be able to engage in voice-communication service, e.g., having a voice interface, a dialing interface, and/or other such hardware and software, to allow a user to place and receive calls and engage in voice communication in those calls.

Such a UE may store configuration data that designates the UE as a “voice-centric” device, which may indicate that the device prioritizes voice-call service over general data service or otherwise that the device should be able to provide voice-call service. As a voice-centric device, the UE may be configured to avoid connecting with or staying connected with a wireless network if that network would not be able to provide the UE with voice-call service (e.g., if the network does not have specific procedures in place for setting up and supporting voice calls), and the UE may fall back to use a different network that supports providing voice-call service even if that different network may not provide the UE with as good general data service. For instance, if the voice-centric UE discovers coverage of a 5G NR network but determines that the 5G NR network does not support providing the UE with voice-call service, the voice-centric UE may responsively fall back to connect instead with a 4G LTE network that supports voice-call service, in order to have voice-call service, even though the 4G LTE network may provide the UE with lower data throughput than the 5G NR network would.

In contrast, a “data-centric” device may be a device that prioritizes data service over voice service. Such a device may be configured to connect with a best available wireless network that may provide the device with the best data service, regardless of whether the network would also be able to provide the device with voice-call service. For instance, faced with a choice between a 5G NR network that does not yet support voice-call service and 4G LTE network that supports voice-call service, the data-centric device may connect with the 5G NR network to benefit from higher data throughput even though the 5G NR network would not have procedures in place to set up and support voice calls for the device.

In addition to being a voice-capable device, the above process may also assume as a basic matter that the UE is configured to permit use of the IMS APN. Of relevance here, as noted above, a UE may be configured with configuration data that defines an ACL indicating which APNs (or more generally which services) the UE is allowed to use—or which APNs the UE is not allowed to use. For instance, this ACL may be provisioned in a Subscriber Identity Module (SIM) of the UE pursuant to a service subscription, and it may list APNs that the UE is permitted to use and thus that the UE is considered to support. One such APN may be an IMS APN.

When a voice-centric UE first powers on or otherwise enters into coverage of a wireless network, the UE may refer to its ACL to determine whether the ACL allows use of the IMS APN, e.g., whether the ACL lists the IMS APN as a supported APN or does not indicate that the IMS APN is not supported. (In practice, the UE may first determine from its configuration settings that the UE is voice-centric, and the UE may then then check its ACL for IMS APN support in response to the UE being voice-centric; alternatively, a voice-centric UE may simply be configured to check its ACL for IMS APN support.)

If the voice-centric UE finds that its ACL allows use of the IMS APN, then the UE may proceed as discussed above to request establishment of the IMS APN. For instance, as part of or after the UE's registration with the core network, the UE may send an APN connection request, asking the core network to set up for the UE the IMS APN, and the core network may responsively do so. The UE may then place and receive voice calls through the IMS as noted above.

On the other hand, if the voice-centric UE finds that its ACL does not allow use of the IMS APN, then this may pose a problem. Given that the ACL does not allow use of the IMS APN, the UE may not request establishment of the IMS APN from the wireless network. Further, given that the UE would therefore not be able to obtain IMS voice-call service from the wireless network, the UE may end up falling back to use an earlier generation wireless network in an effort to get voice-call service, or the UE may altogether fail to connect. One way or another, this could pose a user-experience issue.

In general, the ACL in a voice-centric UE should allow use of the IMS APN, perhaps assuming the UE's subscription plan with a wireless network provider includes IMS voice service. However, for various reasons, the ACL in a voice-centric UE may not allow use of the IMS APN. For example, by human or machine error, the UE's ACL may be misconfigured. Unfortunately, the result of this misconfiguration may be problematic as noted above.

As noted above, the present disclosure provides a mechanism to help address the technical problem where a UE that is equipped to support voice-communication service is for some reason configured to disallow a voice-call service. In accordance with the disclosure, a UE that is equipped to support voice-communication service will detect that the UE is not configured to allow the voice-call service (e.g., that the UE is not configured to allow the UE to use the voice-call service), and, in response to at least the detecting that the UE is configured to not allow the voice-call service, the UE will automatically reconfigure itself to allow the voice-call service.

Without limitation, the disclosed mechanism may address a scenario where an ACL in a voice-centric UE does not list an IMS APN as an allowed APN, i.e., as an APN that the UE is allowed to use. In accordance with the disclosure, a UE that is voice-centric will detect that an ACL in the UE does not list an IMS APN as an allowed APN, and, in response to at least detecting that the ACL in the UE does not list the IMS APN as an allowed APN, the UE will automatically reconfigure itself, adding the IMS APN to the ACL as an allowed APN.

In an example implementation, the act of the UE adding the IMS APN to the ACL could enable the UE to then make use of IMS voice-call service provided by a serving wireless communication network. For instance, once the UE has added the IMS APN to its ACL, the UE may determine that the ACL allows use of the IMS APN, so the UE may then proceed as discussed above to request establishment of an IMS APN connection, and once that IMS APN connection is established for the UE, the UE may then place and receive IMS-based voice calls.

One additional technical question, however, may be whether the UE is entitled to make use of the IMS APN. For instance, at issue may be whether the UE has an active service-subscription that includes IMS voice-call service, so that a wireless communication system with which the UE connects would allow the UE to use IMS voice-call service.

A wireless communication system with which the UE connects may maintain or have access to a service-subscription profile record for the UE, which may indicate whether or not the UE is entitled to use IMS voice-call service, i.e., whether or not the UE is allowed to use IMS voice-call service. When the UE requests the core network of that system to establish an IMS APN connection for the UE, the control-plane subsystem of the core network may then refer to that profile record to determine and thus control whether or not to establish the IMS APN connection for the UE. If the UE's profile record indicates that the UE is entitled to use IMS voice-call service, then, based at least on that indication, the control-plane subsystem may respond to the UE's request for establishment of an IMS APN connection by establishing for the UE the IMS APN connection. Whereas, if the UE's profile record does not indicate that the UE is entitled to use IMS voice service, then, based at least on that indication, the control-plane subsystem may deny the UE's request to establish an IMS APN connection, thus preventing the UE from using IMS voice-call service.

In an example implementation, the UE may make use of this core-network control as a basis for the UE to control whether to have the UE's ACL list the IMS APN. For instance, if the UE requests the core network to establish an IMS APN connection for the UE and the core network grants that request and thus establishes the IMS APN connection for the UE, then, based at least on the core network granting that request, the UE may conclude that the UE's ACL should list the IMS APN—consistent with the core network's decision. Whereas, if the UE requests the core network to establish an IMS APN connection for the UE and the core network denies that request, then, based at least on the core network denying the request, the UE may conclude that the UE's ACL should not list the IMS APN-also consistent with the core network's decision.

The UE can use this added process as a basis to control whether the UE will maintain the IMS APN in the UE's ACL (e.g., after the UE has added the IMS APN to the UE's ACL, or in other situations for that matter) or as a basis to control whether the UE will add the IMS APN to the UE's ACL.

In one implementation, for instance, when the voice-centric UE detects that its ACL does not list the IMS APN and the UE therefore adds the IMS APN to its ACL, that adding of the IMS APN to the UE's ACL could function to put the UE in a test mode in which the UE can then determine whether the wireless communication system will allow the UE to use the IMS APN and thus whether the UE should keep the added IMS APN in its ACL. Namely, adding the IMS APN to the UE's ACL could allow the UE to then request the core network to establish an IMS APN connection for the UE (i.e., in compliance with the ACL), and the core network's response to the UE's request for an IMS APN connection could then serve to control whether or not the UE should keep the added IMS APN in its ACL.

With this implementation, if the core network grants the UE's request to establish an IMS APN connection for the UE and thus establishes the IMS APN connection for the UE, then, based at least on the core network granting that request, the UE may conclude that it is indeed entitled to use the IMS APN, and therefore the UE may maintain the added IMS APN in its ACL. Whereas, if the core network denies the UE's request to establish the IMS APN connection for the UE, then, based at least on the core network denying that request, the UE may conclude that the UE is not actually entitled to use the IMS APN, and therefore the UE may remove the added IMS APN from the ACL (and the UE may possibly set an internal flag that would cause the UE to avoid trying again to request the IMS APN at least with respect to that wireless communication system).

Alternatively, in another implementation, the UE could try requesting establishment of the IMS APN connection before the UE adds the IMS APN to its ACL (i.e., even though the UE's ACL does not list the IMS APN), and the UE could use the core network's response to that request as a basis to control whether the UE will add the IMS APN to its ACL in the first place.

With this implementation, if the core network grants the UE's request to establish an IMS APN connection for the UE and thus establishes the IMS APN connection for the UE, then, based at least on the core network granting that request, the UE may conclude that it is entitled to use the IMS APN, and therefore the UE may add the IMS APN to its ACL. Whereas, if the core network denies the UE's request to establish the IMS APN connection for the UE, then, based at least on the core network denying that request, the UE may conclude that the UE is not entitled to use the IMS APN and, therefore, the UE may not add the IMS APN to its ACL (and the UE may likewise possibly set an internal flag that would cause the UE to avoid trying again to request the IMS APN at least with respect to that wireless communication system).

In still another implementation, when a UE that is voice-centric detects that its ACL does not list an IMS APN as an allowed APN, rather than responding by adding the IMS APN to its ACL and/or testing to see whether to add the IMS APN to its ACL, the UE may respond by reconfiguring itself (i) from being a voice-centric UE to instead being a data-centric UE and possibly (ii) to use an over-the-top voice-call service instead of the IMS voice-call service.

For instance, the voice-centric UE may respond to detecting the absence in its ACL of the IMS APN by changing the UE's stored configuration data that designates the UE as voice-centric to instead designate the UE as data-centric. Once the UE is set as a data-centric UE, the UE may then no longer be concerned with whether or not the UE's ACL lists the IMS APN as an allowed APN. The UE could instead simply acquire the best wireless connectivity that it can find, obtaining a general data connection (e.g., Internet APN), and, through that data connection, the UE could then use an over-the-top (OTT) voice-call service for placing and receiving voice calls.

Using an example OTT voice-call service may involve engaging in packet-based voice-call setup and communication with an OTT voice-call application server on the internet, without the need for any special voice-call setup and management functions to be carried out by the core network or wireless service provider—though also without benefitting from the suitable QoS (e.g., dedicated bearer service) that the core network would provide for calls that it sets up and manages.

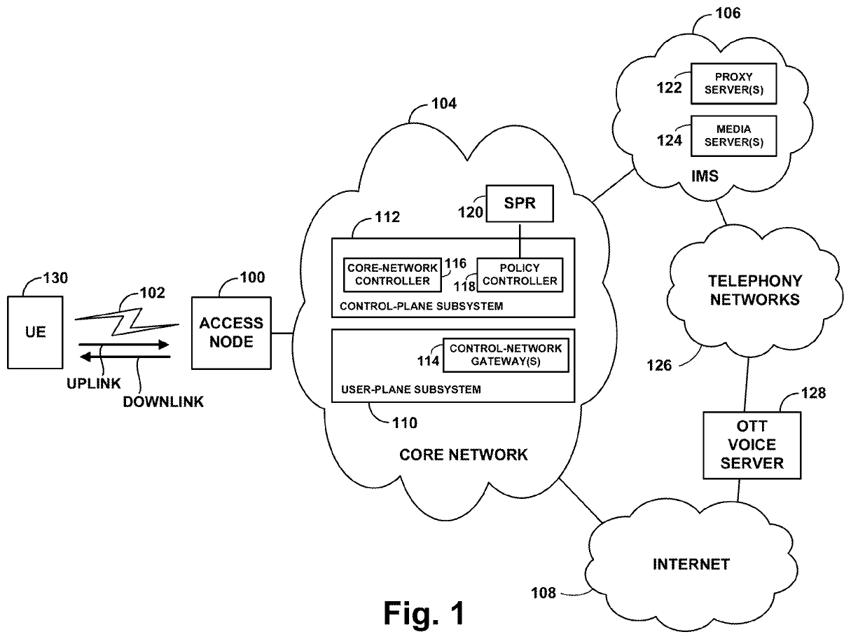

Referring to the drawings, as noted above, FIG. 1 is a simplified block diagram of an example communication system. It should be understood that this and other arrangements and processes described herein are set forth for purposes of example only, and that the disclosed arrangements and processes can take various other forms. For instance, elements and operations can be re-ordered, distributed, replicated, combined, omitted, added, or otherwise modified. Further, it will be understood that functions described herein as being carried out by one or more entities could be implemented by and/or on behalf of those entities, through hardware, firmware, and/or software, such as by one or more processing units executing program instructions or the like.

As shown in FIG. 1, the example wireless communication network includes at least one access node 100, which is configured to provide wireless coverage on a radio frequency (RF) carrier 102 that defines a downlink channel for carrying communications from the access node to UEs and an uplink channel for carrying communications from UEs to the access node.

This RF carrier 102 may be either frequency division duplex (FDD), with separate frequency ranges defined respectively for downlink and uplink use, or time division duplex (TDD), with a single frequency range multiplexed over time between downlink and uplink use. Further, the downlink and uplink channels may be structured in a manner that defines physical air-interface resources for carrying both control signaling and user-plane communications between the access node and UEs.

For instance, the air-interface may be divided over time into frames, subframes, and symbol time segments, and over frequency into subcarriers, so as to define an array of resource elements each occupying a respective subcarrier and spanning a respective symbol time segment. Various groups of these resource elements may then be reserved to define control channels for carrying control signaling, and other groups of the resource elements may cooperatively define physical resource blocks for carrying user-plane data.

On the downlink, for example, certain resource elements may cooperatively define a reference channel in which the access node may broadcast a reference signal that UEs could measure as a basis to evaluate the access node's coverage strength. Further, other resource elements may cooperatively define a physical broadcast channel (PBCH) for carrying system broadcast messages that inform UEs of various system information. In addition, other resource elements may cooperatively define a physical downlink control channel (PDCCH) for carrying various downlink control signaling such as scheduling directives from the access node to UEs. Still further, other resource elements may cooperatively define a physical downlink shared channel (PDSCH) that may be divided into downlink physical resource blocks (PRBs) that the access node could schedule for use to carry user-plane data from the access node to served UEs.

On the uplink, on the other hand, certain resource elements may cooperatively define an access channel for carrying access requests from UEs to the access node. Further, other resource elements may cooperatively define a physical uplink control channel (PUCCH) for carrying various uplink signaling such as measurement reports and scheduling requests from UEs to the access node. Still further, other resource elements may cooperatively define a physical uplink shared channel (PUSCH) that may be divided into uplink PRBs that the access node could schedule for use to carry user-plane data from served UEs to the access node.

As further shown in FIG. 1, the example access node 100 sits as a node on a core network 104 that provides connectivity with various other networks including an IMS 106 and the internet 108, for instance. The core network 104 may be a 4G evolved packet core (EPC) network or a 5G next-generation core network, among other possibilities, and, as shown, may include a user-plane subsystem 110 and a control-plane subsystem 112 as discussed above.

The user-plane subsystem 110 may include one or more core-network gateways 114 that interface between the core network 104 and the various other networks such as the IMS 106 and internet 108. Further, the user-plane subsystem 110 may include various routers and/or other network infrastructure (not shown) to facilitate carrying user-plane traffic (e.g., general data, SIP signaling, voice communication, etc.) between the access node 100 and the one or more core-network gateways 114, in order to enable UEs served by the access node 100 to engage in packet-data communication with various remote entities-such as with components of the IMS or entities accessible through the internet.

The control-plane subsystem 112, on the other hand, may include various control entities or control functions for managing UE and core-network service. Among other entities, for instance, the control-plane subsystem 112 may include a main core-network controller 116 such as a Mobility Management Entity (MME) or Access and Mobility Management Function (AMF), and a policy controller 118 such as a Policy Charging and Rules Function (PCRF) or Policy Control Function (PCF).

The main core-network controller 116 may be responsible for engaging in control-plane signaling with served UEs and for triggering or coordinating various core-network control-plane functions such as setting up APN connections and bearers for instance. Further, the policy controller 118 may function as a policy decision point and controller for directing various core-network control functions. For instance, the policy controller 118 may have access to a subscriber profile repository (SPR) 120 that stores service-subscription profile records for various UEs, and the policy controller 118 may govern whether or not the control-plane subsystem 112 will carry out certain operations for UEs based on the terms of the UEs' subscriptions, such as whether or not to set up certain APN connections or bearers of certain quality levels, among other possibilities.

As shown, the IMS 106 may include various proxy servers 122 and various media servers 124. The proxy servers 122 may facilitate advanced SIP signaling or the like to set up and manage real-time packet-based media sessions such as VoIP calls, and the media servers 124 may facilitate bridging, routing, and other handling of the media traffic such as voice communication traffic. The proxy servers 122 and media servers 124 may connect with one or more telephony networks 126 such as the Public Switched Telephone Network (PSTN) and/or various VoIP-based networks, to facilitate setup and carrying voice calls between served UEs and devices via those other networks 126. Further, the proxy servers 122 and media servers 124 may also be interconnected with the core network 104, to facilitate SIP signaling between served UEs and the proxy servers 122, to facilitate media communication between the served UEs and the media servers 124, and to facilitate signaling communication between the proxy servers 122 and the core-network policy controller 118, among other possibilities.

Shown as a node on the internet 108 an OTT voice server 128, which may also connect with the one or more networks 126 to facilitate setup and carrying of voice calls. As noted above, a served UE might be able to engage in voice-call service through a general data connection, by interacting with such an OTT voice server 128. Although, as noted above, when using an OTT voice-call service, the UE may not benefit from the advanced QoS that the core network could provide for voice-calls that the core network is involved with setting up and managing, such as IMS-based voice calls for instance.

FIG. 1 also illustrates an example UE 130 within coverage of the access node 104. This UE 130 is preferably a voice-centric UE as discussed above, which may subscribe to wireless communication service provided by a wireless service provider (i.e., a carrier or operator). As such, the UE may have an associated service-subscription profile record stored in the SPR 120. In an example implementation, the wireless service provider with which the UE subscribes may own and operate the access node 100 and the core network 104 and/or may have roaming or Mobile Virtual Network Operator (MVNO) agreements to allow the UE to be served by the access node 100 and core network 104.

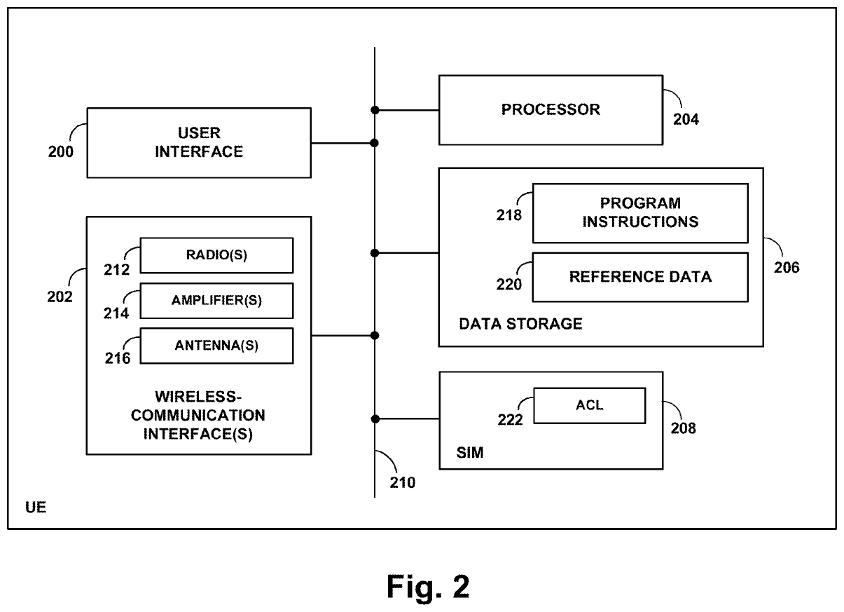

FIG. 2 is a simplified block diagram showing some of the components that an example of UE 130 may include. As shown, the UE 130 may include a user interface 200, a wireless communication interface 202, a processor 204, non-transitory data storage 206, and a SIM 208. These components could be integrated together and/or communicatively linked together in various ways. For instance, the components could be linked together through a system bus, network, or other connection mechanism 210. Alternatively, various integrations and other arrangements are possible. For instance, the processor 204 could be a component of the wireless communication interface 202. Further, there could be dedicated connections (e.g., serial interfaces) to facilitate secure communication between certain components, such as between the processor 204 and the SIM 208, among other possibilities.

The user interface 200 could comprise components that would allow the UE to receive user input and provide user output, such as to support voice-call communication. For instance, the user interface 200 may include one or more input components (not shown) such as a microphone, a keypad, and a touch-sensitive display. Further, the user interface 200 may include one or more output components (not shown) such as a sound speaker and a display screen. Still further, the user interface 200 may include analog-digital conversion circuitry, for converting voice input to a digital representation of the voice and for converting a digital representation of voice into speech output.

The wireless communication interface 202 could comprise one or more modules (e.g., one or more chipsets) configured to facilitate wireless communication between the UE and access nodes according to one or more RATs, such as 4G LTE, 5G NR, and/or one or more other protocols. As shown, for instance, the wireless communication interface 202 may include one or more radios 212, one or more amplifiers 214, and one or more antennas 216. The one or more radios 212 may include one or more radio transmitters configured to modulate baseband signals onto radio frequency RF carriers and one or more radio receivers configured to demodulate baseband signals from one or more RF carriers. The one or more amplifiers 214 may be configured to amplify outbound signals for transmission and/or inbound signals for processing. And the one or more antennas 216 may be configured to transmit and/or receive RF signals. The wireless communication interface 202 may further include various circuitry and/or other logic to facilitate operation according to one or more RATs.

The processor 204 could comprise one or more general purpose processors (e.g., one or more microprocessors, etc.) and/or one or more special-purpose processors (e.g., digital signal processors, application-specific integrated circuits, etc.) Further, the non-transitory data storage 206 could comprise one or more volatile and/or non-volatile storage components (e.g., optical, magnetic, or flash storage, RAM, ROM, EPROM, EEPROM, cache memory, and/or other computer-readable media, etc.), possibly integrated in whole or in part with the processor 204. As shown, the non-transitory data storage 206 may store program instructions 218, which may be executable by the processor 204 to carry out various operations described herein. Further, the non-transitory data storage 206 may store reference data 220, such as configuration data, among other possibilities.

The SIM 208 may be a traditional removable SIM card or an embedded SIM (eSIM). As an eSIM, for instance, the SIM 208 could take the form of secure element (e.g., dedicated system on a chip (SoC)), particularly an embedded universal integrated circuit card (eUICC), which may be soldered or otherwise mounted to a system board of the UE and may serve to hold and manage eSIM profiles. Such an eSIM may include its own processor and data storage (not shown) as well as a communication interface (not shown) through which to engage in direct, secure communication with the processor 204.

The example SIM 208 is shown holding an ACL 222, which as noted above may list or otherwise indicate APNs that the UE is allowed to use. The SIM 208 may store this ACL within one or more data tables for instance, possibly as part of an eSIM profile for the UE's service subscription. The UE may be provisioned with this eSIM profile and/or otherwise with the ACL 222 through over-the-air service provisioning or in other ways. Further, in some implementations, the UE may provide an interface through which an authorized user may modify the ACL 222, such as to manually add or remove APNs.

Returning to FIG. 1, in an example implementation, when UE 130 initially powers on in coverage of access node 100, the UE may scan for a reference signal that indicates the presence of wireless coverage and may discover that access node 100 provides the strongest available coverage. Further, the UE may read broadcast signaling from the access node 100, which may inform the UE that the access node 100 and its associated core network support the IMS APN. In addition, the UE may refer to the UE's stored configuration data to determine that the UE is voice-centric (or this may be implicit), and the UE may refer to the UE's ACL to determine what APNs the UE is allowed to use, including whether the UE is allowed to use the IMS APN.

Assuming the UE is voice-centric and its ACL indicates that it is allowed to use the IMS APN, the UE may then proceed to connect with the access node 100 and register with the core network 104, so that the UE can then engage in IMS-based voice-call service.

In particular, the UE may first engage in signaling with the access node in order to establish an air-interface connection through which the access node could then serve the UE. For instance, the UE may engage in random-access signaling and connection signaling, such as Radio Resource Control (RRC) signaling, with the access node to establish an air-interface connection (e.g., an RRC connection) between the access node and the UE, thereby transitioning the UE from an idle mode to a connected mode.

The UE may then further engage in attach or registration signaling to register for service with the core network. For instance, the UE may send an attach or registration request to the access node, which the access node may forward to the main core-network controller 116 for processing, to trigger authentication and registration of the UE and setting up one or more APN connections for the UE.

The APN connection-establishment process may take various forms.

In a 4G LTE network, for instance, the UE may specify in its attach request to the core-network controller 116 each APN that the UE supports, and the core-network controller 116 may then respond to that attach request not only by authenticating and registering the UE but also by engaging in signaling to trigger or coordinate setup for the UE of an APN connection for each supported APN specified by the UE. Namely, for each such APN, this may include engaging in control signaling that results in assigning to the UE of an IP address at a respective core-network gateway and setting up for the UE of a respective default bearer for carrying user-plane traffic of the APN between the UE and the gateway.

In a 5G NR network, on the other hand, the UE may first engage in registration with the core network, and the UE may then send to the core-network controller 116 a PDU Session Establishment Request specifying each APN supported by the UE, which may likewise lead to core network signaling that results in setting up for the UE of an APN connection for each such supported APN, including assigning to the UE of a respective IP address and setting up for the UE of a respective default bearer.

As to each APN for which the UE requests the core network to set up a connection for the UE, the core network may consult the UE's service-subscription profile record (e.g., in SPR 120) to determine whether the UE is entitled to use the service of that APN, and the core network may control whether or not to set up the APN connection based on that determination. As noted above, for instance, in response to the UE's request for the core network to set up for the UE an IMS APN, the core network may determine from the UE's profile record whether the UE subscribes to IMS service (e.g., IMS voice-call service), and the core network may proceed to set up the IMS APN for the UE only if that determination is affirmative.

If the core network determines that the UE is entitled to have both an Internet APN and an IMS APN, the core network 104 may then establish for the UE both an Internet APN connection and an IMS APN connection as discussed above. Further, the UE may then use the UE's default IMS bearer to register with the IMS 106 as discussed above, so that the UE can then engage in IMS-based voice-call service. Then when a voice call is thereafter initiated to or from the UE, the IMS 106 may then responsively signal to the core network 104 to trigger setup for the UE of a dedicated IMS bearer (i.e., a dedicated voice bearer), and the UE may then engage in the voice call through that dedicated IMS bearer.

As further noted above, the present disclosure provides a mechanism that could address a scenario where a voice-centric UE's ACL does not list the IMS APN. Namely, as discussed above, the UE could respond to this example scenario by automatically adding the IMS APN to the UE's ACL. Further, the UE could do as a test to determine whether the UE is able to obtain IMS service, such as whether the UE's serving core network will establish an IMS APN connection for the UE, and the UE may use a result of that test as a basis to control whether the UE's ACL should include the IMS APN, such as whether to maintain the IMS APN in the ACL or whether to add the IMS APN to the ACL for instance.

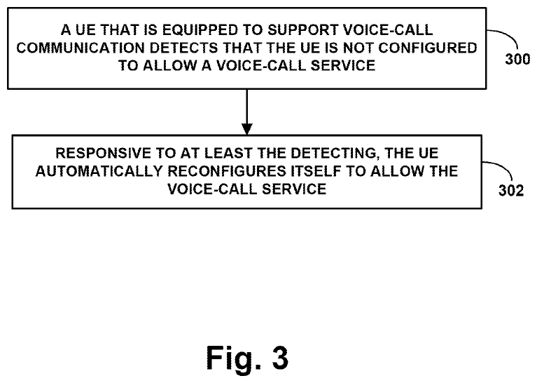

FIG. 3 is a flow chart illustrating a method that a UE may carry out accordingly. As shown in FIG. 3, at block 300, the method includes a UE that is equipped to support voice-call communication detecting that the UE is not configured to allow a voice-call service. Further, at block 302, the method includes, responsive to at least the detecting, the UE automatically reconfiguring itself to allow the voice-call service.

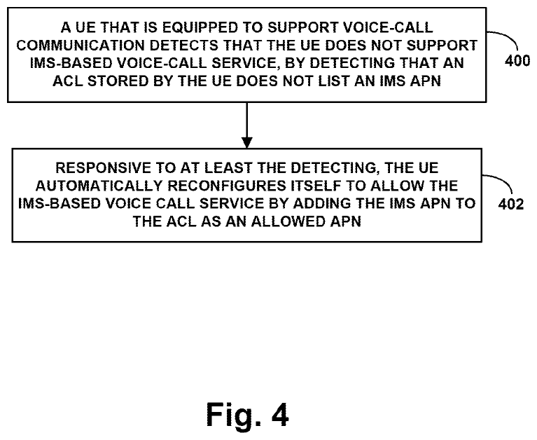

FIG. 4 is next a flow chart illustrating more specifically a method that a UE may carry out. As shown in FIG. 4, at block 400, the method includes a UE that is equipped to support voice-call communication detecting that the UE does not support IMS-based voice-call service, by detecting that an ACL stored by the UE does not list an IMS APN. At block 402, the method then includes, responsive to at least the detecting, the UE automatically reconfiguring itself to allow the IMS-based voice call service by adding the IMS APN to the ACL as an allowed APN.

In line with the discussion above, this method may additionally include the UE detecting (e.g., determining by reference to configuration data stored in the UE) that the UE is voice-centric, in which case the act of the automatically reconfiguring itself to allow the IMS-based voice-call service could be responsive to at least a combination of (i) the UE detecting that the UE is voice-centric and (ii) the UE detecting that the ACL does not list the IMS APN as an allowed APN.

Further, as discussed above, the method could additionally involve the UE conducting a test to determine whether a wireless communication system with which the UE connects allows the UE to have an IMS APN connection, in which case the act of the UE automatically configuration itself to allow the IMS-based voice-call service could be responsive to at least a combination of (i) the UE detecting that the ACL does not list the IMS APN as an allowed APN and (ii) the test establishing that the wireless communication system allows the UE to have an IMS APN connection.

Alternatively, as discussed above, the method could additionally involve the UE conducting at test to determine whether a wireless communication system with which the UE connects allows the UE to have an IMS APN connection, in which case the method could also involve the UE controlling, based at least on a result of the test, whether to retain the added IMS APN in the ACL or rather to remove the added IMS APN from the ACL.

As noted above, the act of the UE conducting the test to determine whether the wireless communication system with which the UE connects allows the UE have an IMS APN connection could involve the UE requesting the wireless communication system to establish the IMS APN connection for the UE and the UE receiving from the wireless communication system a response that is either a grant of the request or a denial of the request, with the response possibly being based on service subscription profile of the UE.

Further, as noted above, the act of the UE controlling, based at least on a result of the test, whether to remove the IMS APN from the ACL could involve (i) if the response is the grant of the request, then, based at least on the response, the UE retaining the added IMS APN in the ACL and (ii) if the response is the denial of the request, then, based at least on the response, the UE removing the added IMS APN from the ACL.

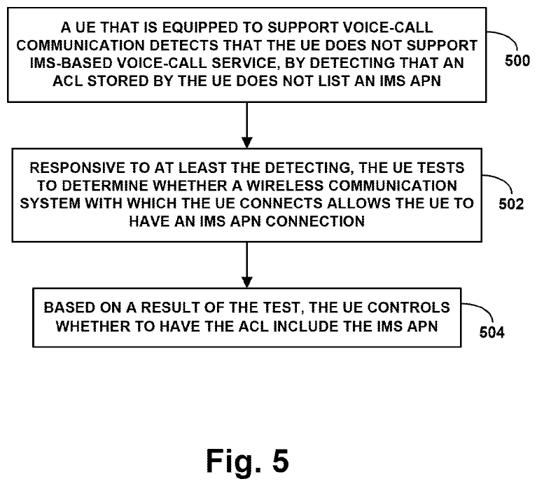

FIG. 5 is next another flow chart illustrating more specifically a method that a UE may carry out accordingly. As shown in FIG. 5, at block 500, the method includes a UE that is equipped to support voice-call communication detecting that the UE does not support IMS-based voice-call service, by detecting that an ACL stored by the UE does not list an IMS APN. At block 502, the method then includes, responsive to at least the detecting, testing by the UE to determine whether a wireless communication system with which the UE connects allows the UE to have an IMS APN connection. Further, at block 504, the method includes, based on a result of the test, controlling by the UE whether to have the ACL include the IMS APN.

As noted above, the present disclosure also contemplates a device configured to carry out operations such as those discussed above. Further, the present disclosure likewise contemplates a non-transitory computer-readable medium (e.g., optical, magnetic, or flash storage, RAM, ROM, EPROM, EEPROM, etc.) having stored thereon program instructions executable by a processor to cause a device to carry out various operations such as those discussed above.

Example embodiments have been described above. Those skilled in the art will understand, however, that changes and modifications may be made to these embodiments without departing from the true scope and spirit of the invention.

What is claimed is:

1. A method comprising:
detecting, by a user equipment device (UE) that is equipped to support voice-call communication, that the UE is not configured to allow a voice-call service; and
responsive to at least the detecting, the UE automatically reconfiguring itself to allow the voice-call service.

2. The method of claim 1, wherein the voice-call service is Internet Protocol (IP) Multimedia Subsystem (IMS) based voice-call service, wherein the UE stores an Access Point Name (APN) Control List (ACL), wherein detecting by the UE that the UE is not configured to allow the voice-call service comprises detecting by the UE that the ACL does not list an IMS APN as an allowed APN, and wherein the UE automatically reconfiguring itself to allow the voice-call service comprises the UE adding the IMS APN to the ACL as an allowed APN.

3. The method of claim 2, further comprising detecting by the UE that the UE is voice-centric, wherein the automatically reconfiguring is responsive to at least a combination of (i) the UE detecting that the UE is voice-centric and (ii) the UE detecting that the ACL does not list the IMS APN as an allowed APN.

4. The method of claim 2, further comprising conducting, by the UE, a test to determine whether a wireless communication system with which the UE connects allows the UE to have an IMS APN connection, wherein the automatically reconfiguring is responsive to at least a combination of (i) the UE detecting that the ACL does not list the IMS APN as an allowed APN and (ii) the test establishing that the wireless communication system allows the UE to have an IMS APN connection.

5. The method of claim 2, further comprising conducting, by the UE, a test to determine whether a wireless communication system with which the UE connects allows the UE to have an IMS APN connection, and controlling by the UE, based at least on a result of the test, whether to retain the added IMS APN in the ACL or rather to remove the added IMS APN from the ACL.

6. The method of claim 5, wherein conducting by the UE the test to determine whether the wireless communication system with which the UE connects allows the UE have an IMS APN connection comprises requesting by the UE the wireless communication system to establish the IMS APN connection for the UE and receiving by the UE from the wireless communication system a response that is either a grant of the request or a denial of the request, wherein the response is based on service subscription profile of the UE.

7. The method of claim 6, wherein controlling by the UE, based at least on a result of the test, whether to remove the IMS APN from the ACL comprises:
if the response is the grant of the request, then, based at least on the response, retaining by the UE the added IMS APN in the ACL; and
if the response is the denial of the request, then, based at least on the response, removing by the UE the added IMS APN from the ACL.

8. A user equipment device (UE) comprising:
a user interface;
a wireless communication interface;
a processor;
non-transitory data storage; and
program instructions stored in the non-transitory data storage,
wherein the UE is equipped to support voice-call communication, and wherein the program instructions are executable by the processor to carry out operations including:
detecting that the UE is not configured to allow the voice-call service, and
responsive to at least the detecting, automatically reconfiguring the UE to allow a voice-call service.

9. The UE of claim 8, wherein the voice-call service is Internet Protocol (IP) Multimedia Subsystem (IMS) based voice-call service, wherein the UE stores an Access Point Name (APN) Control List (ACL), wherein detecting that the UE is not configured to allow the voice-call service comprises detecting that the ACL does not list an IMS APN as an allowed APN, and wherein automatically reconfiguring the UE to allow the voice-call service comprises adding the IMS APN to the ACL as an allowed APN.

10. The UE of claim 9, further comprising a Subscriber Identity Module (SIM), wherein the ACL is stored in the SIM.

11. The UE of claim 9, wherein the operations additionally include detecting that the UE is voice-centric, wherein the automatically reconfiguring is responsive to at least a combination of (i) the detecting that the UE is voice-centric and (ii) the detecting that the ACL does not list the IMS APN as an allowed APN.

12. The UE of claim 9, wherein the operations additionally include conducting a test to determine whether a wireless communication system with which the UE connects allows the UE to have an IMS APN connection, wherein the automatically reconfiguring is responsive to at least a combination of (i) the detecting that the ACL does not list the IMS APN as an allowed APN and (ii) the test establishing that the wireless communication system allows the UE to have an IMS APN connection.

13. The UE of claim 9, wherein the operations additionally include:
conducting a test to determine whether a wireless communication system with which the UE connects allows the UE to have an IMS APN connection, and
controlling, based at least on a result of the test, whether to retain the added IMS APN in the ACL or rather to remove the added IMS APN from the ACL.

14. The UE of claim 13, wherein conducting the test to determine whether the wireless communication system with which the UE connects allows the UE have an IMS APN connection comprises requesting the wireless communication system to establish the IMS APN connection for the UE and receiving from the wireless communication system a response that is either a grant of the request or a denial of the request, wherein the response is based on service subscription profile of the UE.

15. The UE of claim 14, wherein controlling, based at least on a result of the test, whether to remove the IMS APN from the ACL comprises:
if the response is the grant of the request, then, based at least on the response, retaining the added IMS APN in the ACL; and
if the response is the denial of the request, then, based at least on the response, removing the added IMS APN from the ACL.

16. A non-transitory computer-readable medium having stored thereon instructions executable by a processor to cause a UE to carry out operations, wherein the UE is equipped to support voice-call communication, and wherein the program instructions are executable by the processor to carry out operations including:
detecting that the UE is not configured to allow a voice-call service; and
responsive to at least the detecting, automatically reconfiguring the UE to allow the voice-call service.

17. The non-transitory computer-readable medium of claim 16, wherein the voice-call service is Internet Protocol (IP) Multimedia Subsystem (IMS) based voice-call service, wherein the UE stores an Access Point Name (APN) Control List (ACL), wherein detecting that the UE is not configured to allow the voice-call service comprises detecting that the ACL does not list an IMS APN as an allowed APN, and wherein automatically reconfiguring the UE to allow the voice-call service comprises adding the IMS APN to the ACL as an allowed APN.

18. The non-transitory computer-readable medium of claim 17, wherein the operations additionally include detecting that the UE is voice-centric, wherein the automatically reconfiguring is responsive to at least a combination of (i) the detecting that the UE is voice-centric and (ii) the detecting that the ACL does not list the IMS APN as an allowed APN.

19. The non-transitory computer-readable medium of claim 17, wherein the operations additionally include:
conducting a test to determine whether a wireless communication system with which the UE connects allows the UE to have an IMS APN connection, and
controlling, based at least on a result of the test, whether to retain the added IMS APN in the ACL or rather to remove the added IMS APN from the ACL.

20. The non-transitory computer-readable medium of claim 19,
wherein conducting the test to determine whether the wireless communication system with which the UE connects allows the UE have an IMS APN connection comprises requesting the wireless communication system to establish the IMS APN connection for the UE and receiving from the wireless communication system a response that is either a grant of the request or a denial of the request, wherein the response is based on service subscription profile of the UE, and
wherein controlling, based at least on a result of the test, whether to remove the IMS APN from the ACL comprises (i) if the response is the grant of the request, then, based at least on the response, retaining the added IMS APN in the ACL and (ii) if the response is the denial of the request, then, based at least on the response, removing the added IMS APN from the ACL.
